(19) United States
(12) Patent Application Publication
(10) Pub. No.: US 2013/0240490 A1
(43) Pub. Date: Sep. 19, 2013

(54) WELDING METHOD

(71) Applicants: Huijun Wang, Peoria, IL (US); Howard W. Ludewig, Groveland, IL (US); Keith M. Egland, Peoria, IL (US); Glenn A. Forthofer, Metamora, IL (US)

(72) Inventors: Huijun Wang, Peoria, IL (US); Howard W. Ludewig, Groveland, IL (US); Keith M. Egland, Peoria, IL (US); Glenn A. Forthofer, Metamora, IL (US)

(73) Assignee: Caterpillar Inc., Peoria, IL (US)

(21) Appl. No.: 13/421,043

(22) Filed: Mar. 15, 2012

(51) Int. Cl. B23K 26/00

(52) U.S. Cl. 219/121.6

(57) ABSTRACT

A tack welding method for use with a hybrid laser arc welding process. The method provides a recess on an edge of a first piece. The edge of the first piece is configured to cooperate with a second piece. The method positions the first piece relative to the second piece so as to provide a gap between the first piece and the second piece. Subsequently, the method provides a tack weld within the recess of the first piece. The recess is configured to accommodate placing the tack weld at a root of the gap.

### TECHNICAL FIELD

The present disclosure relates to a welding method and more particularly to a tack welding method complementary to a hybrid laser arc welding process.

### BACKGROUND

Hybrid laser arc welding and laser beam welding for joining work pieces is known. Hybrid laser arc welding combines laser beam welding and arc welding, typically gas metal arc welding. U.S. Pat. No. 7,312,417 relates to a laser beam welding process which ensures maintaining a maximal gap width between the sheets and makes possible a maximal utilization of the achievable welding speed. The sheets, prior to welding, are first spot welded, wherein they are clamped only during this spot welding in order to ensure the maintenance of a maximum gap width. However, for narrow groove weld geometries (i.e. the width of the gap is approximately ½ the depth or less), tack welds may not penetrate fully to the root of the weld joint, causing the work pieces to buckle when a final seam weld is applied.

### SUMMARY OF THE DISCLOSURE

In one aspect of the present disclosure, a method of forming a tack weld is provided. The method provides a recess on an edge of a first piece. The edge of the first piece is configured to cooperate with a second piece. The method positions the first piece relative to the second piece so as to provide a gap between the first piece and the second piece. Subsequently, the method provides a tack weld within the recess of the first piece. The recess is configured to accommodate placing the tack weld at a root of the gap.

Other features and aspects of this disclosure will be apparent from the following description and the accompanying drawings.

### BRIEF DESCRIPTION OF THE DRAWINGS

FIG. 1 is a side view of an exemplary set up of a first work piece and a second work piece, according to an embodiment of the present disclosure;

FIG. 2 is a top view of the exemplary set up shown in FIG. 1;

FIG. 3 is a side view of the exemplary setup of the first and second work piece shown in FIG. 1 joined by a tack weld;

FIG. 4 is a side view of the exemplary setup of FIG. 3 including a backing material; and

FIG. 5 shows a schematic process of forming the tack weld.

### DETAILED DESCRIPTION

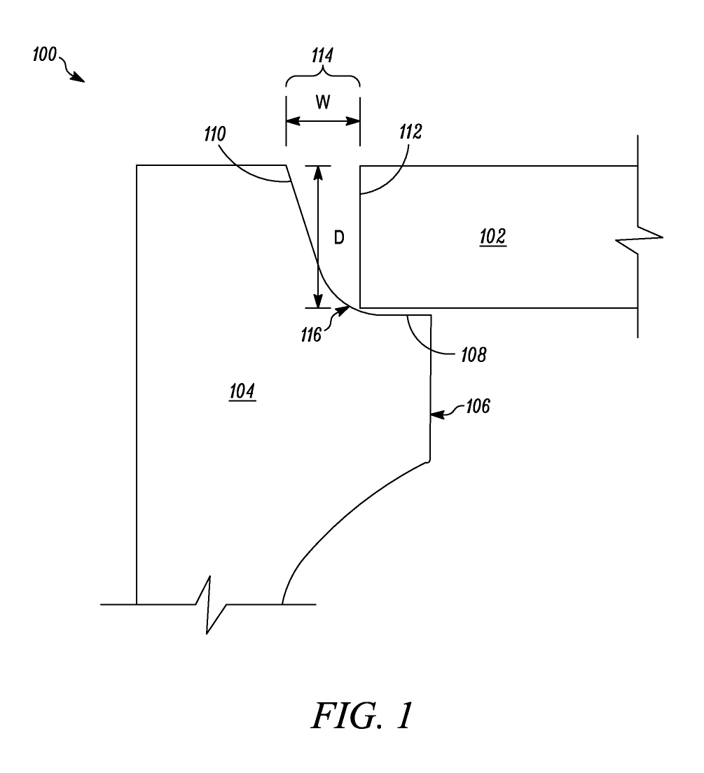

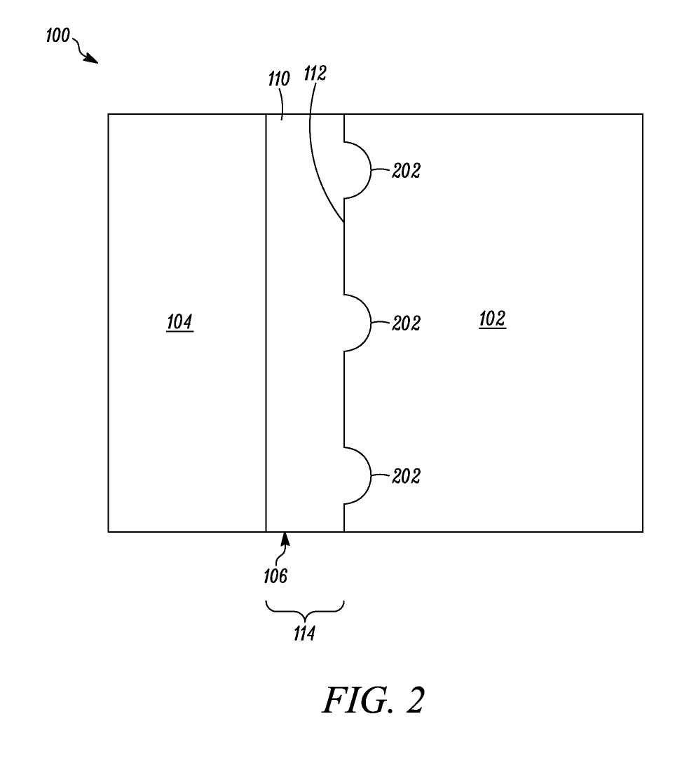

FIG. 1 is an exemplary setup 100 including a first piece 102 and a second piece 104, according to one embodiment of the disclosure. As shown in FIGS. 1 and 2, the first piece 102 may be configured as a plate and second piece 104 may be configured to include a rail section 106. The rail section 106 may include a support section 108 configured to cooperate with the first piece 102 and a sloping edge section 110. The first piece 102 may be configured to include a generally vertical edge 112 proximate to and facing sloping edge section 110. The configuration of the sloping edge section 110 and the vertical edge 112 forming what is commonly called a J-groove weld joint 114. It should be understood that the setup 100 may represent a rail assembly for an engine end frame of a medium wheel loader, a channel assembly for a motor grader, track roller frame, and the like.

A weld joint 114 may be defined as the gap between the first piece 102 and the second piece 104. The configuration of the first piece 102 relative to the second piece 104 may define a width W and a depth D for the weld joint 114, as shown in FIG. 1. Narrow groove weld joints may be defined as having a width W that is approximately ½ the depth D or less. In one embodiment, the weld joint 114 may be a narrow J-groove joint, as shown in the accompanied figures. The dimensions of the weld joint 114 may vary. However, in one exemplary embodiment, the weld joint 114 may have a depth of 8 mm and a top opening width of 3 mm to 4 mm.

It should be understood that the weld joint 114 described herein may have a relatively smaller weld joint size as compared to that typically used for gas metal arc welding. The weld joint 114 may be relatively narrow such that it may be utilized for hybrid laser arc welding or laser beam welding of the first and second pieces 102, 104. Moreover, the weld joint 114 described herein is merely on an exemplary basis. Although the present disclosure is being described herein primarily with respect to J-groove weld joints, it should be apparent that the present disclosure may be applied to other weld geometries, such as single bevel joint with backing material, and the like, which also lie within the scope of the disclosure.

As shown in FIG. 2, a recess 202 may be provided on the vertical edge 112 of the first piece 102. In one embodiment, the recess 202 may be configured to have an arcuate shape. In another embodiment, a plurality of recesses 202 may be provided on the first piece 102. Parameters related to the recess 202 such as size and distance between two consecutive recesses 202 may vary. For example, a recess 202 provided on a plate having a thickness (weld depth) of 8 mm may be configured with a concave semi-circular shape having a radius of 5 mm. The size of the recess 202 may be based on factors like thickness or other dimensions of the first piece 102.

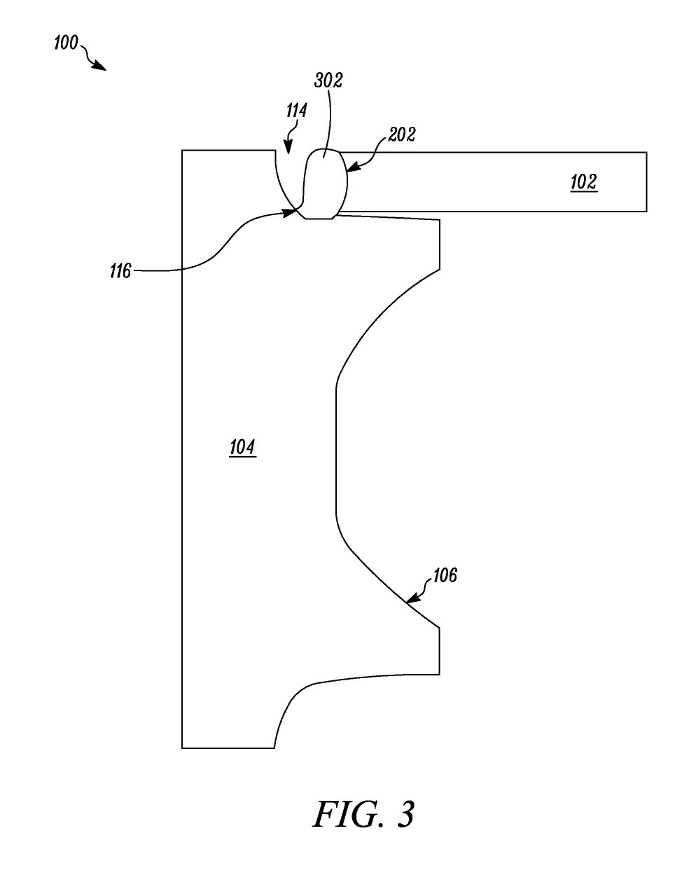

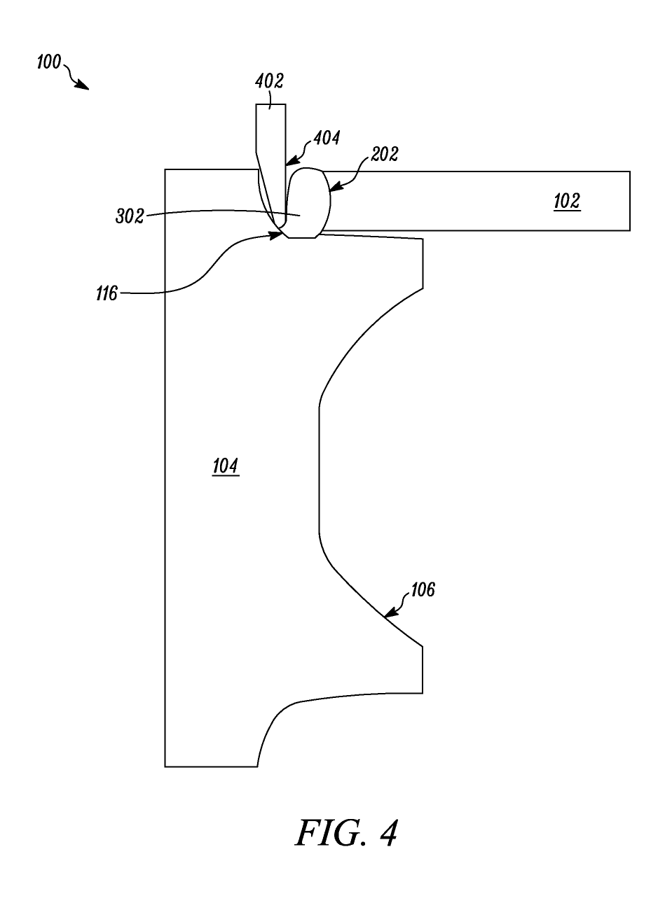

The recess 202 may be configured to accommodate reception of a tack weld 302. In one embodiment, as shown in FIGS. 3 and 4, the recess 202 is provided on the first piece 102 such that the recess 202 may increase space for accommodation of the tack weld 302 at a root 116 of the weld joint 114.

As shown in the FIGS. 3 and 4, the tack weld 302 may be provided in the recess 202 of the first piece 102 and in contact with the second piece 104. The tack weld 302 may be positioned at the root 116 of the weld joint 114. A person of ordinary skill in the art will appreciate that the tack weld 302 may be provided by any known method such as, for example, gas metal arc welding.

In another embodiment of the present disclosure, as shown in FIG. 4, a backing material 402 may be placed within the weld joint 114 when making the tack weld 302. The backing material 402 may include a piece of ceramic, copper, or other suitable material. The backing material 402 may include at least one sharp edge 404. The shape, size and dimensions of the backing material 402 may vary. The backing material 402 may be configured to form a straight edge on the tack weld 302.

In one embodiment, a hybrid laser arc welding method may be used to join the first piece 102 and the second piece 104. After providing the tack weld 302 in the recess 202 of the first piece 102, and the second piece 104 a laser beam may be directed at the root 116, melting a portion of the first and second pieces 102, 104 forming a molten pool. A welding electrode may be placed in the weld joint 114 formed by the first and second pieces 102, 104 to deposit welding material within the weld joint 114 by an arc welding method. The welding material combines with the molten pool, thereby forming a seam between the first and second pieces. The welding electrode may be a solid, metal core or flux core welding electrode. The laser beam may be a sharp focus or de-focused laser beam. Depending on the size of the weld joint 114, a center of the laser beam may be aligned to a center of the weld joint 114 or with some offset. It should be noted that, for the exemplary embodiment, the laser beam to electrode distance may vary between 0 to 8 mm.

The hybrid laser arc welding may involve using a gas metal arc welding torch and the laser beam. In an exemplary setup, the laser beam may lead and the gas metal arc welding torch may trail in the hybrid laser arc welding process. Moreover, in one embodiment, the gas metal arc welding torch may be positioned substantially perpendicular with respect to a welding direction, while the laser beam may be oriented obliquely with respect to the welding direction. Conversely, in another embodiment, the gas metal arc welding torch may be oriented obliquely with respect to the welding direction, while the laser beam may be substantially perpendicular to the welding direction.

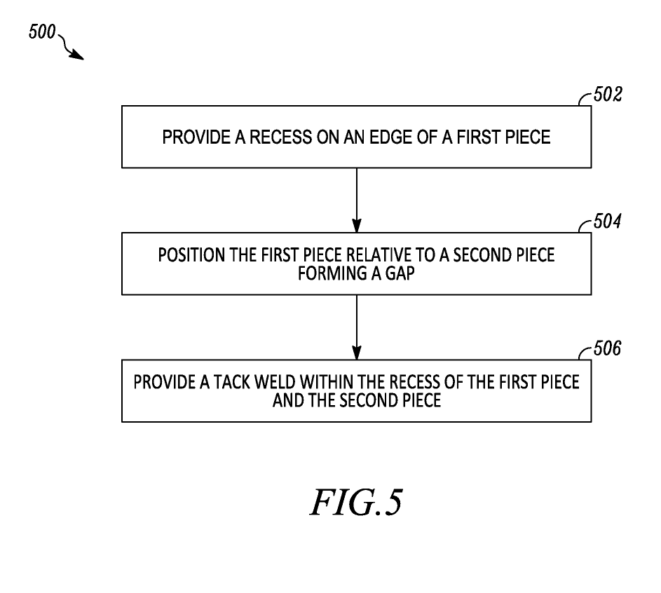

The process of forming the tack welding geometry will be described in detail in connection with FIG. 5.

### INDUSTRIAL APPLICABILITY

Gas metal arc welding is a known welding technique used to join large structural work pieces. Gas metal arc welding has a low energy density, resulting in a high tolerance for joint variability.

If using a gas metal arc welding process, a relatively larger root opening would be required at a joint formed between the first and second pieces 102, 104, in order for the gas metal arc weld to reach a root end of the joint. Hence, in such situations, the larger joint size would have facilitated in providing the tack weld 302 at the root end of the joint formed between the first and second mating surfaces 102, 104.

Another welding technique used is laser beam welding, which makes use of concentrated energy from the laser beam to produce joints with large penetration and very low distortion. However, laser beam welding has relatively lesser tolerance for joint variability.

Hybrid laser arc welding is a welding process that merges the high penetration and welding speed of laser beam welding with a gap-bridging ability of the gas metal arc welding. Hybrid laser arc welding involves combining gas metal arc welding and laser beam welding to form a welding process which is performed simultaneously in one process zone. It may be understood that depending on the kind of arc, laser beam process used, and other process parameters, the gas metal arc welding process and the laser beam welding process may influence each other in different ways.

Hybrid laser arc welding may hence have an improved weld penetration depth and welding speed compared to any of the gas metal arc welding or laser beam welding processes alone. In hybrid laser arc welding, the size of the weld joint 114 may be reduced compared to a joint configured for a gas metal arc welding process and thus allowing the weld size to become smaller. Hybrid laser arc welding may also result in less distortion due to reduced heat input, less filler material required due to a relatively smaller weld size, as well as minimized joint preparation due to elimination of beveling requirements. Also, time required for joint completion may be reduced.

However, in hybrid laser arc welding, the reduced size of the weld joint 114 leads to the tack weld 302 to reside at a top portion of the weld joint 114, leading to development of a root gap between the first and second pieces 102, 104. The presence of the tack weld 302 at the top portion of the weld joint 114 may also cause a reduction in the penetration of the hybrid laser arc weld and/or laser beam weld, by obstructing a path of the laser beam to reach the root 116 of the weld joint 114. Further, the tack weld 302 residing at the top portion of the weld joint may also lead to instability of the hybrid laser arc welding process which could result in spatters, welding fumes, porosity, and the like.

One solution may include providing the tack weld 302 from behind the first and second mating surfaces 102, 104. However, in some instances providing the tack weld 302 from the reverse side of the weld joint 114 may not be feasible due to accessibility issues based on factors like enclosed structural design, limited groove size, and the like.

The present disclosure relates to a tack welding method complementary to a relatively narrow grooved joint size. Referring to FIG. 5, initially, at step 502, the recess 202 is provided on the vertical edge 112 of the first piece 102. In one embodiment, a plurality of recesses 108 may be provided on the first piece 102. The recess 202 may be configured to accommodate reception of the tack weld 302. In another embodiment, the recess 202 may be shaped like an arc, semi-circle, or similar configuration. Parameters related to the recess such as size, shape, dimensions, and the like may vary, without limiting the scope of the disclosure.

Subsequently, at step 504, the first piece 102 may be positioned relative to the second mating surface 104 to define the weld joint 114 between the first and second pieces 102, 104. In one embodiment, the weld joint 114 may be configured as a J-groove joint, a single bevel joint, a flare joint, and the like. It should be understood that the disclosure may be utilized in any application making use of a narrow groove weld joint 114 as disclosed herein. The disclosure may also be utilized in regular grooved joints without any limitation.

At step 506, the tack weld 302 is provided within the recess 202 between the first piece 102 and the second piece 104. The recess 202 on the vertical edge 112 of the first piece 102 is provided such that the tack weld 302 may be accommodated at the root 116 of the weld joint 114. It should be understood that the recess 202 provided on the vertical edge 112 of the first piece 102 may increase the space between the first and second pieces 102, 104 to accommodate the reception of the tack weld 302 at the root 116 of the weld joint 114. The tack weld 302 when provided at the root 116 of the weld joint 114 may hold the first and second pieces 102, 104 in a tight and strong manner.

In one embodiment, as shown in FIG. 4, the backing material 402 may be placed in the weld joint 114 when the tack weld 302 is being made. The backing material 402 may be made of ceramic.

When the backing material 402 is being used, the recess 202 of the first piece 102 may be initially half-filled or filled such that at least a portion of the recess 202 is provided with the tack weld 302. The tack welding is provided by suitably placing a welding wire and melting the root 116 of the weld joint 114. Subsequently, the backing material 402 may be placed in the weld joint 114 such that the sharp edge 404 of the backing material 402 is in contact with the tack weld 302, causing the straight edge to be formed on the tack weld 302. Then, a remaining portion of the recess 202 may be fully filled by the tack weld 302. It may be understood that the tack welding may be provided by any known method.

The backing material 402 may be configured to form a straight edge on the tack weld 302. The straight edge formed on the tack weld 302 may facilitate in subsequent welding of the first and second pieces 102, 104 using the laser beam. The formation of the straight edge may result in less metal in the weld joint 114, facilitating the laser beam to melt the root 116 of the weld joint 114 without a lack of fusion or porosity defect.

Thereafter, the first and second pieces 102, 104 may be joined together by a known welding method. In one embodiment, hybrid laser arc welding may be used. A person of ordinary skill in the art will appreciate that the first and second pieces 102, 104 and the weld joint 114 described above are merely on an exemplary basis. Other applications not described herein also lie within the scope of this disclosure.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. A welding method for joining a first piece and a second piece, the method comprising:
providing a recess on an edge of the first piece, the edge of the first piece configured to cooperate with the second piece;
positioning the first piece relative to the second piece so as to provide a gap between the first piece and the second piece; and
providing a tack weld within the recess of the first piece, wherein the recess is configured to accommodate placing the tack weld at a root of the gap.

2. The method of claim 1, wherein a plurality of recesses are provided at a pre-determined location on the edge of the first piece.

3. The method of claim 1, wherein the recess is configured to have an arcuate shape.

4. The method of claim 1, wherein the gap between the first piece and the second piece is configured to define at least one of the group consisting of a narrow J-shaped groove, a single bevel joint, and a flare joint.

5. The method of claim 1 wherein providing the tack weld further includes:
filling at least a portion of the recess of the first piece with weld material;
placing a backing material in the grooved joint and in contact with the weld material, the backing material configured to form a straight edge on the tack weld; and
filling a remaining portion of the recess of the first mating surface with additional weld material.

6. The method of claim 5, wherein the backing material is made of a ceramic.

7. The method of claim 1, wherein the tack weld is provided using gas metal arc welding.

8. The method of claim 1 further including joining the first piece and the second piece using a hybrid laser arc welding method.

9. The method of claim 8, wherein the hybrid laser arc welding method includes positioning a gas metal arc welding torch substantially perpendicular with respect to a welding direction and positioning a laser beam oblique with respect to the welding direction during the hybrid laser arc welding method.

10. The method of claim 8, wherein the hybrid laser arc welding method includes positioning a gas metal arc welding torch oblique with respect to a welding direction and a laser beam is substantially perpendicular with respect to the welding direction during the hybrid laser arc welding method.

11. A welding method for joining a first piece and a second piece, the method comprising:
providing a recess on an edge of the first piece, the edge of the first piece configured to cooperate with the second piece;
positioning the first piece relative to the second piece so as to provide a gap configured to define a narrow J-groove between the first piece and the second piece; and
providing a tack weld within the recess of the first piece, wherein the recess is configured to accommodate placing the tack weld at a root of the narrow J- groove.

12. The method of claim 11, wherein a plurality of recesses are provided at pre-determined locations on the edge of the first piece.

13. The method of claim 12, wherein the recess is configured to have an arcuate shape.

14. The method of claim 11 wherein providing the tack weld further includes:
filling at least a portion of the recess of the first piece with weld material;
placing a backing material in the narrow J-groove and in contact with the weld material, the backing material configured to form a straight edge on the tack weld; and
filling a remaining portion of the recess of the first piece with the additional weld material.

15. The method of claim 14, wherein the backing material is made of a ceramic.

16. The method of claim 11, wherein the tack weld is provided using gas metal arc welding.

17. The method of claim 11 further including joining the first piece and the second piece using a hybrid laser arc welding method.

18. The method of claim 17, wherein a gas metal arc welding torch is substantially perpendicular with respect to a welding direction and a laser beam is oblique with respect to the welding direction during the hybrid laser arc welding method.

19. The method of claim 17, wherein a gas metal arc welding torch is oblique with respect to a welding direction and a laser beam is substantially perpendicular with respect to the welding direction during the hybrid laser arc welding method.

20. A welding method for joining a first piece and a second piece, the method comprising:
providing at least one recess on an edge of the first piece, the edge of the first piece configured to cooperate with the second piece;
positioning the first piece relative to the second piece so as to provide a gap between the first piece and the second piece;
providing a tack weld within the at least one recess of the first piece by filling at least a portion of the at least one recess with weld material, wherein the at least one recess is configured to accommodate placing the weld material at a root of the gap; and
joining the first piece and the second piece by forming a seam using a hybrid laser arc welding method, wherein the hybrid laser arc welding method includes directing a laser beam at the root of the gap and depositing weld material within the gap with a gas metal arc welding torch.
